(19) United States
(12) Patent Application Publication
(10) Pub. No.: US 2004/0132394 A1
(43) Pub. Date: Jul. 8, 2004

(54) Cutting-off apparatus

(75) Inventor: Takao Harikawa, Shiga Prefecture (JP)

Correspondence Address: BANNER & WITCOFF, 1001 G STREET N W, SUITE 1100, WASHINGTON, DC, 20001, US

(73) Assignee: Shiga Yamashita Co., Ltd., Shiga Prefecture (JP)

(21) Appl. No.: 10/737,919

(22) Filed: Dec. 18, 2003

Related U.S. Application Data
(62) Division of application No. 10/090,729, filed on Mar. 6, 2002.

(30) Foreign Application Priority Data
Sep. 28, 2001 (JP) 2001-300250
May 28, 2001 (JP) 2001-003355

(51) Int. Cl. B28D 1/04; B24B 7/00

(52) U.S. Cl. 451/547; 125/13.01

(57) ABSTRACT

An apparatus A for cutting off an unnecessary object deposited on a casting includes a motor having a rotary shaft 3 adapted to be rotated at a high speed, and a disk-shaped diamond tip saw 2 mounted at a tip end 4 of the rotary shaft 3 and adapted to be rotated by the rotation of the rotary shaft 3 to cut off the unnecessary object 9 on the casting 8, so that the tip saw 2 is rotated at a rotational speed in a range of 6,000 rpm to 8,000 rpm. Thus, the rigidity of the diamond tip saw 2 rotated at the high speed is increased by a centrifugal force provided by the diamond tip saw 2 itself and a gyroscopic moment effect to reduce the thickness of the diamond tip saw 2 can be reduced by a value corresponding to an increment in rigidity of the tip saw 2, whereby the amount of diamond tips (diamond blades) used can be decreased; an energy-saving for a cutting power can be achieved, and the amount of chips produced upon the cutting of the unnecessary object can be reduced.

### BACKGROUND OF THE INVENTION

1. Field of the Invention

The present invention relates to an apparatus for cutting off an unnecessary object deposited on any of various castings such as automobile parts produced from an aluminum alloy or the like by a casting process, and particularly, to an apparatus for cutting off an unnecessary object, which includes a diamond tip saw for cutting off an unnecessary object such as a gate of a casting, and a rotary device such as a motor for rotating the tip saw. More particularly, the present invention relates to an apparatus for cutting off an unnecessary object deposited on a casting, which includes a diamond tip saw for cutting off an unnecessary object such as a gate deposited on a casting, and a rotary device such as a motor for rotating the tip saw at a high speed, wherein the amount of diamond tips used can be reduced; an energy-saving for a cutting power can be achieved, and the amount of chips produced upon the cutting of the unnecessary object can be reduced to decrease the useless amount of a material for the casting.

2. Description of the Related Art

In general, various parts for an automobile, e.g., a cylinder head, a cylinder block, an intake manifold and the like are produced from an aluminum alloy by a casting process. A casting produced by such casting process has an unnecessary object such as a gate deposited thereon, and it is necessary to cut off the unnecessary object from the casting, thereby remarkably reducing the production cost for the casting.

There is such a conventionally known cutting-off apparatus which includes a diamond tip saw mounted at a tip end of a rotary shaft of a rotary device such as a motor, so that the diamond tip saw is rotated at a high speed by driving the rotary device to cut off an unnecessary object deposited on a casting.

In the conventional apparatus, the rotational speed of the diamond tip saw is in a range of 1,000 to 3,600 rpm, but in order to prevent the occurrence of a vibration during the cutting, the thickness of the tip saw is required to be on the order of 6 to 8 mm, if the diameter of the tip saw is on the order of 400 φ.

The present inventors have found that if the rotational speed of the tip saw is increased to 4,000 rpm or more, an increase in rigidity of the tip saw is provided remarkably by a centrifugal force provided by the tip saw itself and a gyroscopic moment effect and as a result, the thickness of the tip saw can be decreased by a value corresponding to an increment in rigidity of the tip saw. Thus, the present invention has been accomplished from the above finding.

### SUMMARY OF THE INVENTION

Accordingly, it is an object of the present invention to provide an apparatus for cutting off an unnecessary object deposited on a casting, which includes a diamond tip saw for cutting off an unnecessary object such as a gate deposited on a casting, and a rotary device such as a motor for rotating the tip saw at a high speed, wherein the amount of diamond tip used can be reduced; an energy-saving for a cutting power can be achieved, and the amount of chips produced upon the cutting of the unnecessary object can be reduced.

To achieve the above object, according to the present invention, there is provided an apparatus for cutting off an unnecessary object deposited on a casting, comprising a rotary device having a rotary shaft adapted to be rotated at a high speed, and a disk-shaped diamond tip saw mounted at a tip end of the rotary shaft and adapted to be rotated by the rotation of the rotary shaft to cut off the unnecessary object on the casting, so that the tip saw is rotated at a rotational speed of 4,000 rpm or more, whereby the amount of diamond tip used can be reduced; an energy-saving for a cutting power can be achieved, and the amount of chips produced upon the cutting of the unnecessary object can be reduced to decrease the useless amount of a material for the casting, thereby remarkably reducing the production cost for the casting and overcoming the disadvantage associated with the conventionally known technology.

With the above arrangement, by increasing the rotational speed of the diamond tip saw to 4,000 rpm or more, an increase in rigidity of the diamond tip saw is provided remarkably by a centrifugal force provided by the tip saw itself and a gyroscopic moment effect and as a result, the thickness of the tip saw can be decreased by a value corresponding to an increment in rigidity of the tip saw, for example, to 2.5 mm from the range of 6 mm to 8 mm, thereby reducing the cost.

The above and other objects, features and advantages of the invention will become apparent from the following description of the preferred embodiment taken in conjunction with the accompanying drawings.

### BRIEF DESCRIPTION OF THE DRAWINGS

FIG. 1 is a perspective view of an embodiment of a cutting-off apparatus according to the present invention; and

FIG. 2 is an enlarged sectional view of a portion of the apparatus shown in FIG. 1.

### DESCRIPTION OF THE PREFERRED EMBODIMENT

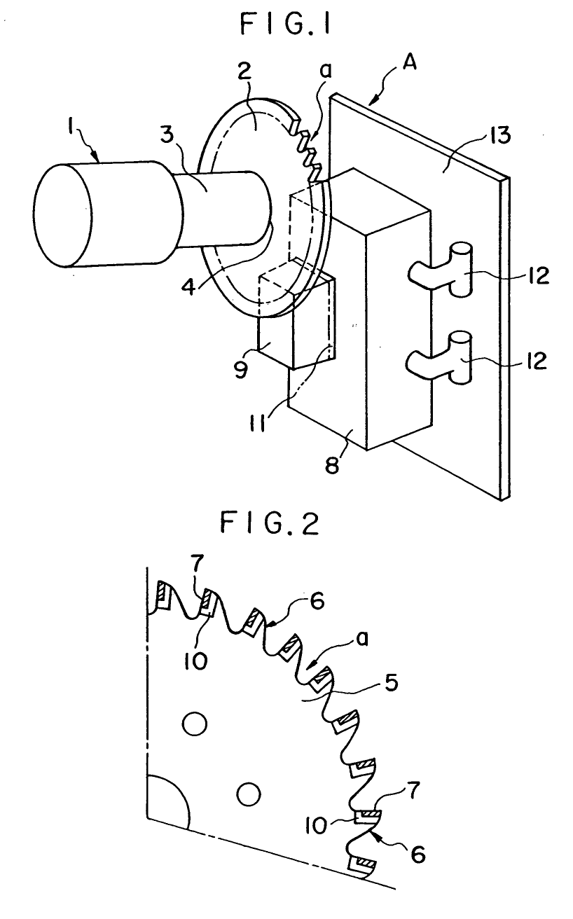

The present invention will now be described by way of an embodiment with reference to FIGS. 1 to 3.

FIG. 1 shows a cutting-off apparatus A according to the present invention. The cutting-off apparatus A includes a rotary device 1 such as a motor and a disk-shaped diamond tip saw 2. The motor 1 (rotary device) includes a rotary shaft 3 having the disk-shaped diamond tip saw 2 mounted at its tip end 4. The rotary shaft 3 of the motor 1 is rotated at a high speed by driving the motor 1, and the disk-shaped diamond tip saw 2 mounted at the tip end 4 of the rotary shaft 3 is also rotated at a high speed with the rotation of the rotary shaft 3.

The disk-shaped diamond tip saw 2 has a tip saw body 5 provided at its peripheral edge with a large number of tips 6 arranged in a circumferential direction, as shown in FIG. 2 which is an enlarged side view of a portion indicated by a in FIG. 1, and diamond blades 7 are mounted to the tips 6, respectively. Each of the diamond blades 7 has a size of, for example, 4 mm×4 mm×1 mm and mounted to carbide portions 10.

The diamond tip saw 2 is rotated in more than 4000 rpm, preferably in the range of 4000 rpm to 10,000 rpm, by the rotation of rotating shaft 3 by a motor 1, to cut-off and to remove an unnecessary object 9 deposited on a casting 8, such as a cylinder head of the engine parts of a car, when casting 8, such as aluminum alloy is produced, as illustrated in FIG. 1.

The diamond tip saw 2 rotated at the high speed has a rigidity remarkably increased by its own centrifugal force and a gyroscopic moment effect, and the thickness of the diamond tip saw 2 can be reduced by a value corresponding to the increment in the rigidity. More specifically, in a prior art cutting-off apparatus including a tip saw having a size on the order of 300 to 400 φ and a cutting shaft rotated at a rotational speed of 1,800 rpm, the thickness of the tip saw is required to be on the order of 6 mm to 8 mm, but according to the present invention, when a gate having an area to be cut of 50 mm×100 mm is cut at a cutting shaft rotational speed of 7, 000 rpm and at a feed rate of 30 mm/sec, the thickness of the tip saw can be 2.5 mm.

By reducing the thickness of the tip saw to 2.5 mm from the range of 6 mm to 8 mm as described above, the amount of diamond tips used is decreased to 4 mm×4 mm×1 mm, and an energy-saving for a cutting power, i.e., a cutting power provided by the motor 1 shown in FIG. 1 is achieved, and the amount of chips produced from a cut portion 11 upon cutting of an unnecessary object 9 on a casting 8 is decreased. This can contribute to a reduction in production cost of the casting. Reference character 12 in FIG. 1 designates clamps 12 secured to a support plate 13 for clamping and retaining the casting 8. Clamps 12 are also mounted to a support plate 13 of an opposed device (not shown) to clamp and retain the casting 8 from opposite sides.

Although the embodiments of the present invention have been described in detail, it will be understood that the present invention is not limited to the above-described embodiments, and various modifications in design may be made without departing from the spirit and scope of the invention defined in claims.

What is claimed is:

1. An apparatus for cutting off an unnecessary object deposited on a casting, comprising a rotary device having a rotary shaft adapted to be rotated at a high speed, and a disk-shaped diamond tip saw mounted at a tip end of the rotary shaft and adapted to be rotated by the rotation of the rotary shaft to cut off the unnecessary object on the casting, so that the tip saw is rotated at a rotational speed of 4,000 rpm or more, whereby the amount of diamond tip used can be reduced; an energy-saving for a cutting power can be achieved, and the amount of chips produced upon the cutting of the unnecessary object can be reduced to decrease the useless amount of a material for the casting.
